(19) United States
(12) Patent Application Publication
(10) Pub. No.: US 2019/0005055 A1
(43) Pub. Date: Jan. 3, 2019

(54) OFFLINE GEOGRAPHIC SEARCHES

(71) Applicant: MICROSOFT TECHNOLOGY LICENSING, LLC, Redmond, WA (US)

(72) Inventors: FELIX GERARD TORQUIL IFOR ANDREW, SEATTLE, WA (US); SILVANA PATRICIA MONCAYO, SEATTLE, WA (US); OLIVER BRUNO COLBERT, SEATTLE, WA (US)

(21) Appl. No.: 15/639,753

(22) Filed: Jun. 30, 2017

(51) Int. Cl. G06F 17/30

(52) U.S. Cl. CPC G06F 17/3087; G06F 17/30867; G06F 17/30241

(57) ABSTRACT

The technology described herein optimally allocates the limited computer storage on the end user device to supplemental search data most likely to be used by a geographic search application. The search data can be selected based on recently received geographic queries. The supplemental search data comprises content that can be used to reproduce web pages that the user has not viewed previously, but are accessible through the search results provided in the queries. The supplemental content allows the user to interact with search results while offline as if online.

### BACKGROUND

Currently, users have limited access to point of interest data when using a map or navigation application offline. Modern map applications provide navigation assistance and query response using a combination of online and offline data. Map applications may store geographic data on a client device that enables the map application to provide directions while disconnected from an external data source, such as an online service. When online, the map applications may retrieve point of interest data from a service and show points of interest along the route, nearby a current location, or as requested, for example, in response to a search query. Little or no point of interest data may be available offline.

The geographic data stored on a user device may include very little information about points of interest on a map, such as restaurants, movie theaters, schools, hospitals, entertainment venues, etc. Mobile devices have limited memory and are not presently able to locally store enough information to generate meaningful geographic search results when offline.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein allows previously run geographic searches to be rerun and interacted with while offline. For example, a user traveling overseas may run a search to find nearby restaurants while in his hotel room connected to Wi-Fi. After the user leaves the hotel, he may wish to rerun the search to find an intended destination while not connected to a data network. The technology described herein stores the search results and supplemental search data (e.g., web page content) that could be accessed through each search result on a client device for offline use.

The technology described herein optimally allocates the limited computer storage on the user device to supplemental search data most likely to be used by a map application when offline. The supplemental search data comprises content needed to reproduce recently run searches and interact with those results even if the user did not interact with them previously. The technology can access web pages associated with search results, store content from those web pages locally so that the user can click on a search result, and access a reproduction of the linked web page. The reproduction of the web page is generated using only locally stored data. In addition, the supplemental information can include data for points of interest not included in the search result, but within the geographic area associated with the search results.

To make the best use of limited storage, the offline data is deleted or augmented when deletion triggers are detected. In one aspect, the deletion trigger is the user accessing a network connection. In another aspect, the deletion trigger is the user leaving a geographic area associated with the search. Other triggers are possible.

### BRIEF DESCRIPTION OF THE DRAWINGS

The technology described herein is illustrated by way of example and not limitation in the accompanying figures in which like reference numerals indicate similar elements and in which:

FIG. 1 is a block diagram of an example operating environment suitable for implementations of the present disclosure;

FIG. 2 is a diagram depicting an example computing architecture suitable for implementing aspects of the present disclosure;

FIG. 3 shows a geographic display showing geographic search results, in accordance with an aspect of the technology described herein;

FIGS. 4-6 are flow diagrams showing exemplary methods of using geographic search result data while offline to generate geographic search results, in accordance with an aspect of the technology described herein; and

FIG. 7 is a block diagram of an exemplary computing environment suitable for use in implementing aspects of the technology described herein.

### DETAILED DESCRIPTION

The various technology described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein allows previously run geographic searches to be rerun and interacted with while offline. For example, a user traveling overseas may run a search to find nearby restaurants while in his hotel room connected to Wi-Fi. After the user leaves the hotel, he may wish to rerun the search to find an intended destination while not connected to a data network. The technology described herein stores the search results and supplemental search data (e.g., web page content) that could be accessed through each search result on a client device for offline use.

The technology described herein optimally allocates the limited computer storage on the user device to supplemental search data most likely to be used by a map application when offline. The supplemental search data comprises content needed to reproduce recently run searches and interact with those results even if the user did not interact with them previously. The technology can access web pages associated with search results, store content from those web pages locally so that the user can click on a search result, and access a reproduction of the linked web page. The reproduction of the web page is generated using only locally stored data. In addition, the supplemental information can include data for points of interest not included in the search result, but within the geographic area associated with the search results.

To make the best use of limited storage, the offline data is deleted or augmented when deletion triggers are detected. In one aspect, the deletion trigger is the user accessing a network connection. In another aspect, the deletion trigger is the user leaving a geographic area associated with the search. Other triggers are possible.

The supplemental search data can be used by a map application running on the user device to produce additional search results or other display. A map application is any application that generates an interface that displays a road map. As used herein, the map application is installed on a user device, such as a smartphone. Because it is installed on the user device, the map application can provide map functionality when the user device is not connected to a network (i.e., offline). The map applications described herein may provide different levels of functionality when online (i.e., connected to a network) or offline. For example, when online, the map application may be able to return search results for any query and any geographic area. The map application can provide both road data and search results on a map when offline.

Different types of map applications exist. For example, some map applications can help a user navigate between two points and may show points of interest along the route, such as restaurants and gas stations. Some map applications use maps in limited circumstances. For example, a search function may show search results on a map in only some contexts when an intent for a geographic result set is detected. The map application can take the form of a personal assistant application.

In an aspect, the map application uses road map data, supplemental search data, and point of interest data stored on the user device to generate a map interface when the user device is offline. The map data stored on the end user device is described herein as “device road map data,” “supplemental search data,” and “device point of interest data.” The device road map data and the device point of interest data are in contrast to “remote road map data,” “remote search data,” and “remote point of interest data” that may be available from a service the map application can access when online.

The supplemental search information for a query can include the search result set provided in response to the query. The supplemental search information for a query can also include supplemental search results not shown to a user. For example, the search result set shown to a user could include 15 search results with the highest relevancy scores. The supplemental search result data could include the next 50 search results, as an example, with the next highest relevancy scores. The search results could then be shown in response to the same query if submitted a second time when the device is offline. All or a portion of the search results could also be shown in response to a different query if the local search application determines that they are responsive to the different query. A new relevance rank may be assigned to each of the search results in response to a new or identical query. For example, a context change between receiving the query while online and receiving the same query offline can change the relevance of different results. For example, the relevance of results to a query “nearby restaurants” can change based on device location when a query is submitted.

The supplemental search data can also include point of interest data for points of interest in an area associated with a geographic query, but that are not in the search results. The point of interest data can be selected based on overall popularity within the geographic area. Popularity could be measured by interaction data collected from people in the area. The more people that visit a point of interest, the more popular it becomes. The point of interest data allows for search results including the point of interest to be generated and shown on a map while offline. Including the point of interest data for the most popular points of interest expands the scope of possible search results to beyond those related to recent queries.

The supplemental search data can also include content from web pages and websites linked to individual search results. In one aspect, each link in the search results is followed and content from the linked web page retrieved. The content can include images and text needed to reproduce the web page while offline. Additionally, links on the linked web page can be followed and content retrieved from those pages in order to display the pages offline. In one aspect, the entire website associated with a linked web page is retrieved for reproduction offline. A size limit may be imposed for larger websites to prevent the entire website from being stored offline. For example, a 10-page limit on a website may be used. The 10 pages with the highest relevance to the query may be selected.

As used herein, “geographic query” means a query associated with a geographic area. As an initial step, the query may be classified as a geographic query and the geographic area of interest determined. The geographic area can be specified implicitly or explicitly in the query. For example, the query “find hardware stores in Overland Park, Kansas” is a geographic query because it is explicitly asking for hardware stores in the city of Overland Park, rather than anywhere. The geographic area, Overland Park, is mentioned explicitly.

The query “find a nearby bike shop” is also a geographic query because the word “nearby” implies that the user is only interested in search results to points of interest nearby the user. Different methods of defining “nearby” can be used. As a starting point, a location of the device may be determined and then a threshold distance from the location may be used to define the area. Alternatively, a user's home location may be used instead of an actual device location. As an alternative to distance, government boundaries (e.g., cities, zip codes, counties) or other methods of delineating areas can be used.

The geographic intent can also be implicit when the most relevant type of entity sought are nearby entities. For example, the queries “gas station,” “car wash,” or “grocery store” all seek points of interest where proximity is important and the closest gas station is likely to be the most relevant search result.

As used herein, “offline” means that an application on a user device does not have access to a data set or service located on a different computing system, such as a data center. The lack of access can be caused by the lack of a wired or wireless network connection between the user device and the different computing system. The lack of access can also be caused by data settings or other settings (e.g., low power mode) on the end user device. For example, the application may not have permission to use a data connection, even though the user device is connected to a network with a data connection. In this situation, some applications can be online and other applications offline, and applications can be offline though the device is online. Network limitations can also cause a lack of access. For example, the network may limit data because of usage limits or other policies meaning the device or application is effectively offline, despite a data connection.

As used herein, “online” means that an application on a user device has access to a data set or service located on a different computing system, such as a data center.

The technology can use contextual signals to determine device and user context. The device and user context may trigger various actions, such as deletion of supplemental search data when conditions indicate it is not likely to be useful to the user. “Contextual signals,” as utilized herein, may reflect any attribute of a user (for instance, physical characteristics), the user's historical interaction with the system (e.g., behavior, habits, and system interaction patterns), and/or the user's recent interaction with the system (with “recency” being defined in accordance with a predetermined time frame relative to a given point in time) that may affect the likelihood or probability that the user desires to engage in a particular activity. Such contextual signals may include, by way of example only and not limitation, the location of the user of the computing device (determined utilizing, for instance, Global Positioning System (GPS) signals, Internet Protocol (IP) address, or the like), the time of day (either general (for instance, morning or afternoon) or exact (for instance, 6:00 pm)), the date (either exact or generally a particular month, season, etc.), a physical characteristic of the user (for instance, if the user is paralyzed and capable of only voice input, or the like), a task currently engaged in on the computing device by the user, a task recently engaged in on the computing device by the user (again with “recency” being defined in accordance with a predetermined time frame relative to a given point in time), an object the user is currently engaged with on the computing device (for instance, an entity such as a contact, a file, an image, or the like), an object the user was recently engaged with on the computing device, a function currently being performed by the user on the computing device, a function recently performed by the user on the computing device, hardware currently being utilized on the computing device, hardware recently utilized on the computing device, software currently being utilized on the computing device, and software recently utilized on the computing device.

Having briefly described an overview of aspects of the technology described herein, an exemplary operating environment in which aspects of the technology described herein may be implemented is described below in order to provide a general context for various aspects.

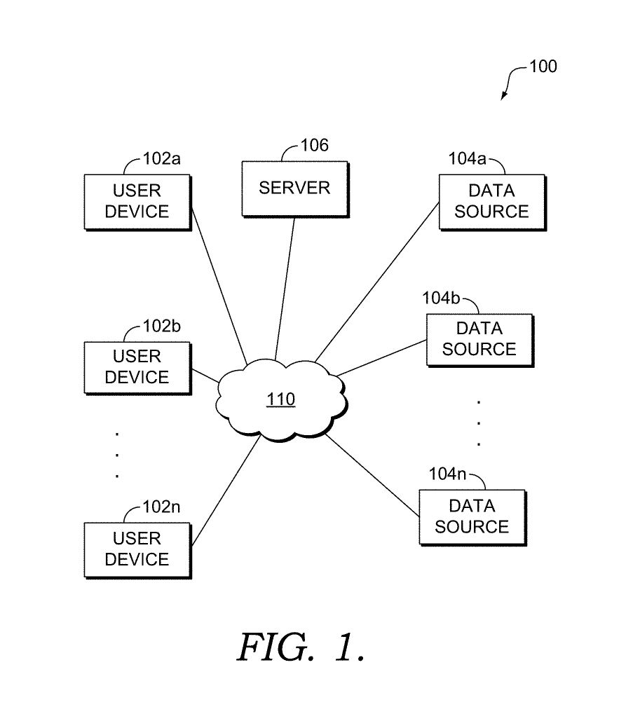

Turning now to FIG. 1, a block diagram is provided showing an example operating environment 100 in which some aspects of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

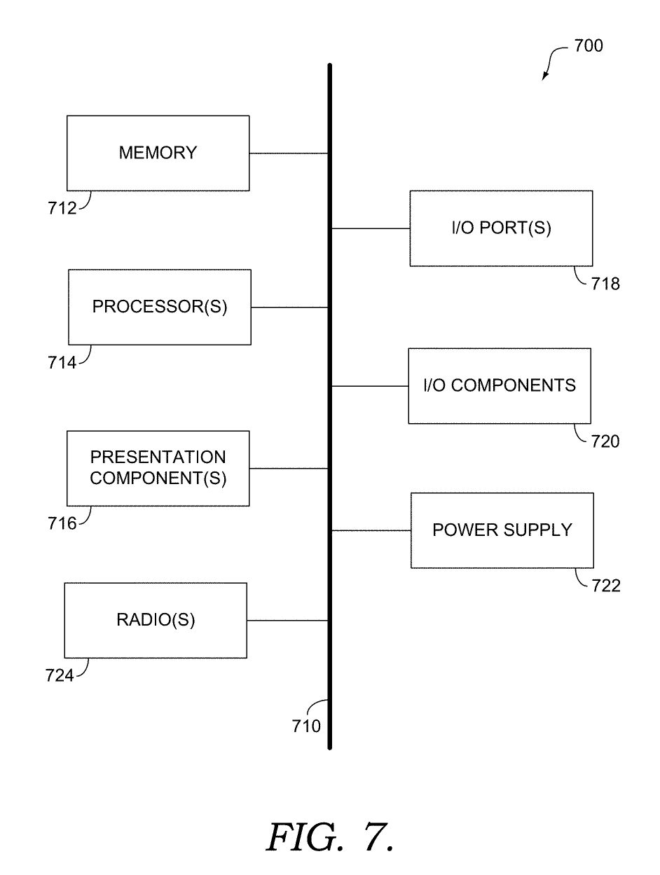

Among other components not shown, example operating environment 100 includes a number of user devices, such as user devices 102a and 102b through 102n; a number of data sources, such as data sources 104a and 104b through 104n; server 106; and network 110. Each of the components shown in FIG. 1 may be implemented via any type of computing device, such as computing device 700 described in connection to FIG. 7, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

User devices 102a and 102b through 102n can be client devices on the client-side of operating environment 100, while server 106 can be on the server-side of operating environment 100. The user devices can facilitate the completion of tasks, such as searching a map application or navigating a route, and make a record of user activities. The devices can belong to many different users and a single user may use multiple devices. The user activities can be analyzed to determine a user's interests, including geographic areas frequented by the user and the types of point of interest data a user may be likely to access.

Server 106 can comprise server-side software designed to work in conjunction with client-side software on user devices 102a and 102b through 102n to implement any combination of the features and functionalities discussed in the present disclosure. For example, the server 106 may run offline data engine 260, which generates supplemental search data for offline use. The server 106 may receive activity records, such as location data, from a large number of user devices belonging to many users. This data can be described as crowdsourced data. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one aspect, user devices 102a through 102n may be the type of computing device described in relation to FIG. 7 herein. By way of example and not limitation, a user device may be embodied as a personal computer (PC), a laptop computer, a mobile device, a smartphone, a tablet computer, a smart watch, a wearable computer, a fitness tracker, a virtual reality headset, augmented reality glasses, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

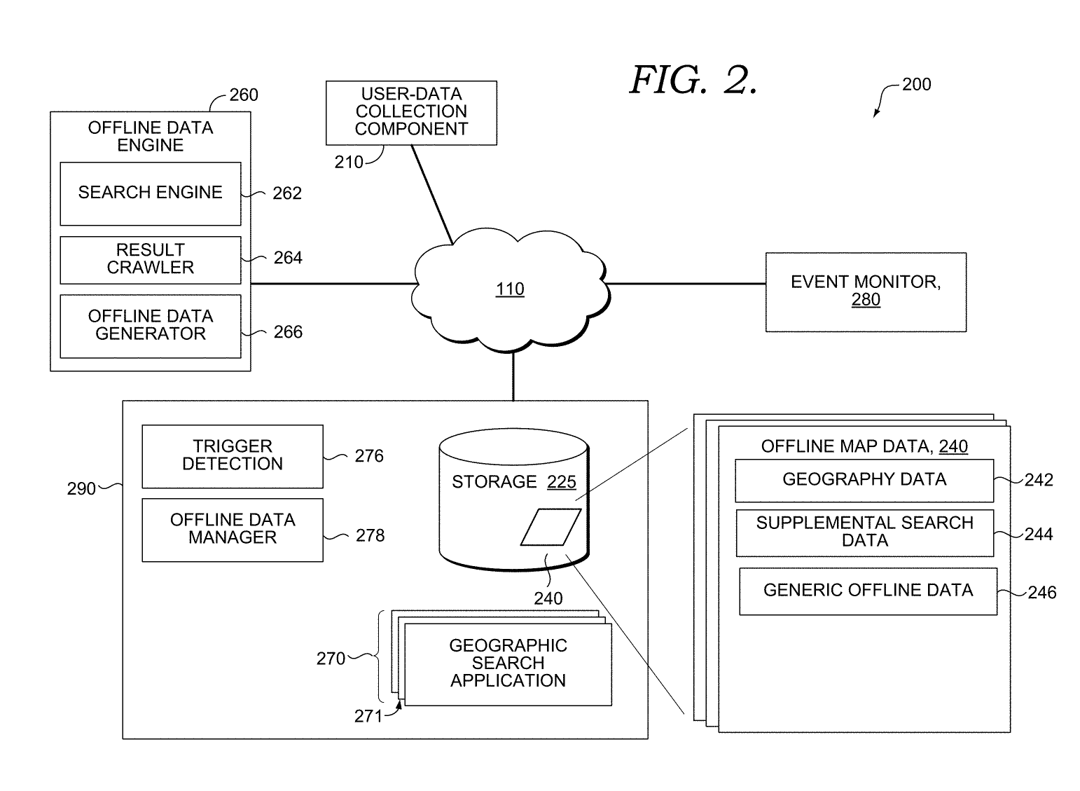

Data sources 104a and 104b through 104n may comprise data sources and/or data systems, which are configured to make data available to any of the various constituents of operating environment 100, or system 200 described in connection to FIG. 2. (For example, in one aspect, one or more data sources 104a through 104n provide (or make available for accessing) user data to user-data collection component 210 of FIG. 2.) Data sources 104a and 104b through 104n may be discrete from user devices 102a and 102b through 102n and server 106 or may be incorporated and/or integrated into at least one of those components. In one aspect, one or more of data sources 104a through 104n comprise one or more sensors, which may be integrated into or associated with one or more of the user device(s) 102a, 102b, or 102n or server 106. Examples of sensed user data made available by data sources 104a through 104n are described further in connection to user-data collection component 210 of FIG. 2. The data sources 104a through 104n can comprise a knowledge base that stores information about maps, points of interest, a user, or other entity related to a particular user action. The data sources 104a through 104n can also include websites associated with search results, points of interest, search engines, and such.

Operating environment 100 can be utilized to implement one or more of the components of system 200, described in FIG. 2, including components for collecting user data, receiving queries, generating search results, generating supplemental search data, and generating search results offline using the supplemental search data.

Referring now to FIG. 2, with FIG. 1, a block diagram is provided showing aspects of an example computing system architecture suitable for implementing an aspect and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively connects components of system 200 including user-data collection component 210, user-event monitor 280, offline data engine 260, and client device 290. The network connection can be unavailable or not used at times. User-event monitor 280, offline data engine 260 (including its components 262, 264, and 266), trigger detection component 276, offline data manager 278, and geographic search applications 270 may be embodied as a set of compiled computer instructions or functions, program modules, computer software services, or an arrangement of processes carried out on one or more computer systems, such as computing device 700 described in connection to FIG. 7, for example.

In one aspect, the functions performed by components of system 200 are associated with one or more personal assistant applications, search services, map applications, search applications, or routines. In particular, such applications, services, or routines may operate on one or more user devices (such as user device 102a), servers (such as server 106), may be distributed across one or more user devices and servers, or be implemented in the cloud. Moreover, in some aspects, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the aspects described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality of specific components shown in example system 200 is described, it is contemplated that in some aspects functionality of these components can be shared or distributed across other components.

Continuing with FIG. 2, user-data collection component 210 is generally responsible for accessing or receiving (and in some cases also identifying) user data from one or more data sources, such as data sources 104a and 104b through 104n of FIG. 1. In some aspects, user-data collection component 210 may be employed to facilitate the accumulation of user data of a particular user (or in some cases, a plurality of users including crowdsourced data) for user-event monitor 280, offline data engine 260, or a geographic search application 270. The data may be received (or accessed), and optionally accumulated, reformatted, and/or combined, by user-data collection component 210 and stored in one or more data stores, where it may be available to other components of system 200. For example, the user data may be stored in or associated with a user profile. In some aspects, any personally identifying data (i.e., user data that specifically identifies particular users) is either not uploaded or otherwise provided from the one or more data sources with user data, is not permanently stored, and/or is not made available to user-event monitor 280 and/or offline data engine 260.

User data may be received from a variety of sources where the data may be available in a variety of formats. For example, in some aspects, user data received via user-data collection component 210 may be determined via one or more sensors, which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both. By way of example and not limitation, user data may include data that is sensed or determined from one or more sensors (referred to herein as sensor data), such as location information of mobile device(s), properties or characteristics of the user device(s) (such as device state, charging data, date/time, or other information derived from a user device such as a mobile device), user-activity information (for example: app usage; online activity; searches; voice data such as automatic speech recognition; activity logs; communications data including calls, texts, instant messages, and emails; website posts; other user-data associated with communication events; etc.) including, in some aspects, user activity that occurs over more than one user device, user history, session logs, application data, contacts data, calendar and schedule data, notification data, social-network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personal assistant application or service), home-sensor data, appliance data, global positioning system (GPS) data, vehicle user data, traffic data, weather data (including forecasts), wearable device data (which may include physiological data about the user such as heart rate, pulse oximeter or blood oxygen level, blood pressure, galvanic skin response, or other physiological data capable of being sensed or detected), other user device data (which may include device settings, profiles, network-related information (e.g., network name or ID, domain information, work group information, connection data, Wi-Fi network data, or configuration data, data regarding the model number, firmware, or equipment, device pairings, such as where a user has a mobile phone paired with a Bluetooth headset, for example, or other network-related information)), gyroscope data, accelerometer data, payment or credit card usage data (which may include information from a user's PayPal account), purchase history data (such as information from a user's Xbox Live, Amazon.com, or eBay account), other sensor data that may be sensed or otherwise detected by a sensor (or other detector) component(s) including data derived from a sensor component associated with the user (including location, motion, orientation, position, user-access, user-activity, network-access, user-device-charging, or other data that is capable of being provided by one or more sensor components), data derived from other data (for example, location data that can be derived from Wi-Fi, cellular network, or IP address data), and nearly any other source of data that may be sensed or determined as described herein.

In some respects, user data may be provided in user-data streams or signals. A “user signal” can be a feed or stream of user data from a corresponding data source. For example, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some aspects, user-data collection component 210 receives or accesses data continuously, periodically, or as needed.

User-event monitor 280 is generally responsible for monitoring user data for information that may be used for identifying and defining point of interest events, which may include identifying and/or tracking features (sometimes referred to herein as “variables”) or other information regarding specific user actions with points of interest. A point of interest event can be used as input to calculate an interest in categories of points of interest, such as Chinese restaurants. The “event” is a way to format relevant information for consumption by an interest classifier. In other words, the event record can follow a data schema that allows the interest classifier to determine interests from the event records. The event's occurrence and details can be inferred from the user data in some cases. For example, a location can be designated as the user's place of work because the user regularly spends time at the location during work hours. Using events, instead of actual data as input, can simplify the process of calculating an interest by providing a more uniform input across users.

In some aspects, information determined by user-event monitor 280 may be provided to offline data engine 260 including information regarding the current context and historical events (historical observations). For example, the event monitor 280 can provide event records for use by the offline data engine 260 or trigger detection component 276. Events can indicate that a trigger condition has been satisfied to delete some or all of the supplemental search data.

In some aspects, user-event monitor 280, one or more of its subcomponents, or other components of system 200, such as offline data engine 260, may determine interpretive data from received user data. Interpretive data corresponds to data utilized by these components of system 200 or subcomponents of user-event monitor 280 to interpret user data. For example, interpretive data can be used to provide other context to user data, which can support determinations or inferences made by the components or subcomponents. Moreover, it is contemplated that aspects of user-event monitor 280, its subcomponents, and other components of system 200 may use user data and/or user data in combination with interpretive data for carrying out the objectives of the subcomponents described herein. Additionally, although several examples of how user-event monitor 280 and its subcomponents may identify user event information are described herein, many variations of event identification and user event monitoring are possible in various aspects.

In aspects using contextual information related to user devices, such as a delete trigger, a user device may be identified by detecting and analyzing characteristics of the user device, such as device hardware, software such as operating system (OS), network-related characteristics, user accounts accessed via the device, and similar characteristics. For example, information about a user device may be determined using functionality of many operating systems to provide information about the hardware, OS version, network connection information, installed application, or the like. In some aspects, a device name or identification (device ID) may be determined for each device associated with a user. This information about the identified user devices associated with a user may be stored in a user profile associated with the user, such as in user account(s). In an aspect, the user devices may be polled, interrogated, or otherwise analyzed to determine contextual information about the devices.

Continuing with system 200 of FIG. 2, offline data engine 260 is generally responsible for determining what supplemental search information should be provided to individual users in response to a query. In some aspects, offline data engine 260 may run on a server, as a distributed application across multiple devices, or in the cloud.

As shown in example system 200, offline data engine 260 comprises search engine 262, result crawler 264, and offline data generator 266. The search engine 262 indexes content, such as web pages, entities, and other data, for retrieval in response to a search query. The search engine 262 receives a query, identifies content related to the query, ranks the content in terms of relevance, generates search results from the content, and outputs the search results. The search engine 262 can be a back-end service that interacts with a web interface or client application.

The search engine 262 can include a classifier that assigns a query to domain for further processing. A classifier could be trained to receive user input and classify a query as a geographic query. A classifier or classifiers could be used to classify a query into an interest category. Generally, the classifier can be trained by inputting representative user data into the classifier and forcing the classifier to calculate a specific score corresponding to a classification. For example, a batch of user data could be input to the classifier and constrained with an interest in baseball. A second batch of user data could be input to the classifier and constrained to an interest in tennis. This process can be repeated until the nodes or features of the classifier are assigned values that result in a similar classification being calculated when similar data is input. Once trained, the classifier can receive a query and generate a classification. The interest classification can be associated with a confidence factor that is also derived from the input. The classifier can receive a large range of values associated with different variables. In some instances, no data will be available for various variables. The difference in the amount of data and type of data as well as the values associated with the data can cause a different confidence score.

The result crawler 264 generates supplemental search content in response to a geographic query. As used herein, “geographic query” means a query associated with a geographic area. As an initial step, the query may be classified as a geographic query and the geographic area of interest determined. In one aspect, supplemental search result data 244 is generated with each geographic search. In another aspect, a trigger condition needs to be satisfied. The trigger may be detected on the client device and a notification sent to the offline data engine 260. In one aspect, the trigger conditions are satisfied when a data shortage is anticipated. For example, a phone may detect the absence of a data connection indicating the probability of the future absence of a data connection in the near future. For example, a phone could be roaming and have access to phone calls and texts, but not data. A user could also have turned off data access through a control panel. In either case, an observed data shortage can be a condition that triggers generation of supplemental search data for some time period after the data shortage is observed.

The supplemental search information 244 for a query can include the search result set provided in response to the query. The supplemental search data for a query can also include supplemental search results not shown to a user. For example, the search result set shown to a user could include 15 search results with the highest relevancy scores. The supplemental search result data could include the next 50 search results, as an example, with the next highest relevancy scores. The search results could then be shown in response to the same query if submitted a second time when the device is offline. All or a portion of the search results could also be shown in response to a different query if the local search application determines that they are responsive to the different query. A new relevance rank may be assigned to each of the search results in response to a new or identical query. For example, a context change between receiving the query while online and receiving the same query offline can change the relevance of different results. For example, the relevance of results to a query “nearby restaurants” can change based on device location when a query is submitted.

The supplemental search data can also include point of interest data for points of interest in an area associated with a geographic query, but that are not in the search results. The point of interest data can be selected based on overall popularity within the geographic area. Popularity could be measured by interaction data collected from people in the area. The more people that visit a point of interest, the more popular it becomes. The point of interest data allows for search results including the point of interest to be generated and shown on a map while offline. Including the point of interest data for the most popular points of interest expands the scope of possible search results to beyond those related to recent queries.

The supplemental search data can also include content from web pages and websites linked to individual search results. In one aspect, each link in the search results is followed by the result crawler 264 and content from the linked web page retrieved. The content can include images and text needed to reproduce the web page while offline. Additionally, links on the linked web page can be followed and content retrieved from those pages in order to display the pages offline. In one aspect, the entire website associated with a linked web page is retrieved for reproduction offline. A size limit may be imposed for larger websites to prevent the entire website from being stored offline. For example, a 10-page limit on a website may be used. The 10 pages with the highest relevance to the query may be selected.

The offline data generator 266 packages supplemental search data and communicates it to a client device for storage and offline use. The offline data generator 266 can track data already stored on a device to avoid communicating the same supplemental search data twice, for example, in response to similar queries or the same query received at different times.

Continuing with FIG. 2, example system 200 includes one or more geographic search applications 270, which comprise applications or services that consume geographic search data to provide geographic search results. The geographic search applications may provide other types of searches, in addition to geographic searches.

In particular, a first example geographic search application 270 comprises a search application. In one aspect, a geographic search application 271 is provided to facilitate providing a personalized geographic search, while offline. The application 271 may work with an online service (not shown), but may also use the local offline map data 240 when offline. Thus, geographic search application 271 may be considered one example of an application that may consume offline map data 240. The geographic search application 271 may receive a query, such as “nearby restaurants,” and provide a search result interface, such as interface 300, described subsequently. The geographic search application 271 may rely entirely on offline map data 240 to generate the interface without accessing a remote service.

The geographic search application 270 could be a map application. A map application is any application that generates an interface that displays a road map. As used herein, the map application is installed on a user device, such as a smartphone. Because it is installed on the user device, the map application can provide map functionality when the user device is not connected to a network (i.e., offline). The map applications described herein may provide different levels of functionality when online (i.e., connected to a network) or offline. For example, when online, the map application may be able to return search results for any query and any geographic area. The map application can provide both road data and search results on a map when offline. The road map data can be found in geography data 242.

Different types of map applications exist. For example, some map applications can help a user navigate between two points and may show points of interest along the route, such as restaurants and gas stations. Some map applications use maps in limited circumstances. For example, a search function may show search results on a map in only some contexts when an intent for a geographic result set is detected. The map application can take the form of a personal assistant application.

In an aspect, the map application uses geography data 242, supplemental search data 244, generic offline data 246, stored on the user device to generate a map interface when the user device is offline. The offline map data stored on the end user device is described herein as “device geography data,” “supplemental search data,” and “device point of interest data.” The device road map data and the device point of interest data are in contrast to “remote geography data,” “remote search data,” and “remote point of interest data” that may be available from a service the map application can access when online. The generic offline data 246 is not related to a search. The generic offline data 246 could include the most popular points of interest in a geographic area. The generic offline data 246 can be used to generate search results in combination with the supplemental search data. For example, popular points of interest in the generic data might be presented on a map as a landmark to orient the viewer.

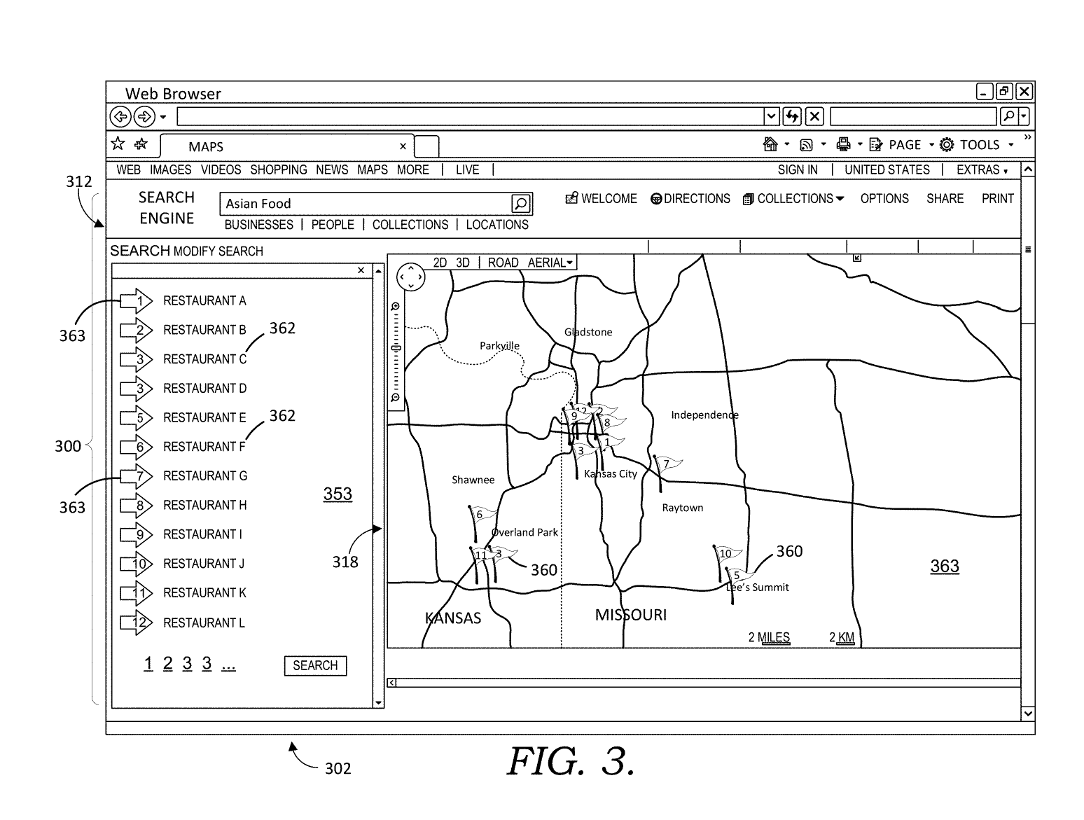

FIG. 3 shows one example of geographic search results. The search interface 300 is displayed in a display pane 312 of a Web browser window 302. The search interface 300 includes a location portion 318 displaying a map 364 that depicts the geographic area around Kansas City, Mo. The search interface also includes a search results pane 353 that provides search results 362 for each point of interest. The search results 362 may be selectable by a user to present a detail page for a particular point of interest. The detail page may be a web page associated with the point of interest in the search result. Each of the results 362 may also include an associated indicator 363 that aids in identifying a corresponding point of interest on the map 364.

The indications (“indicators”) include a graphic, image, or the like that can be displayed on a map. For example, the indicators might include an image or graphic of a flag (indicators 360, FIG. 3), dots, and stars, among a variety of others. The indicators are located on the map at or near the location indicated by the metadata associated with the point of interest that is represented by the indicator. The metadata may provide latitude and longitude for the point of interest. As depicted in FIG. 3, the indicators 360 may include a number or other reference to allow a user to identify the indicators 360 with a corresponding search result listing 362 provided in a search result pane 353. In an embodiment, the indicators are also selectable by a user to present or direct the user to content of the detail page associated with a particular point of interest. The detail page includes additional information not communicated in the search result for the point of interest.

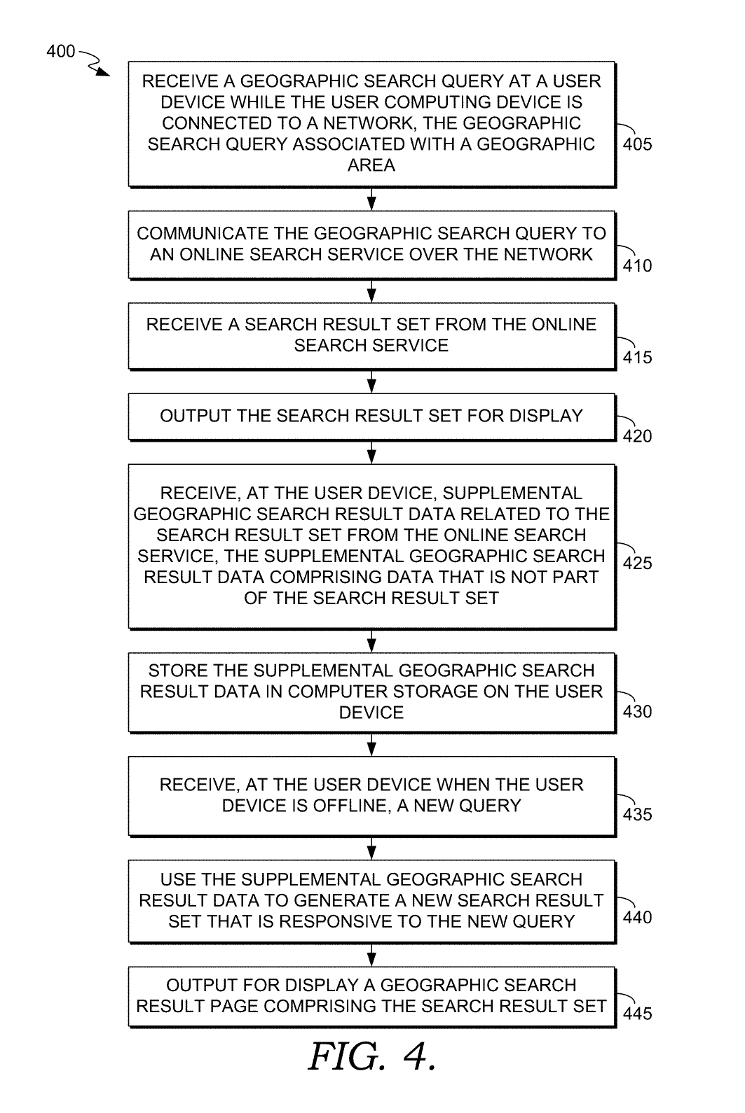

Turning now to FIG. 4, a flow chart showing a method 400 of using geographic search result data while offline to generate geographic search results is provided. Method 400 can be performed on a user device, such as a smartphone, head mounted display, tablet, etc.

At step 405, a geographic search query is received at a user device while the user computing device is connected to a data network. Being connected to a network can also be described as being online. The connection can be wired or wireless. While connected to the network, the application that received the query can communicate with other computing devices and especially search services, such as those provided through a data center associated with an online search engine.

The geographic search query is associated with a geographic area. As an initial step, the query may be classified as a geographic query and the geographic area of interest determined. A geographic query is a query with an intent for results tied to a geographic area. For example, the query “find hardware stores in Overland Park, Kansas” is a geographic query because it is asking for hardware stores in the city of Overland Park, rather than anywhere. The geographic area can be determined implicitly or explicitly. In the previous query, the geographic area, Overland Park, is mentioned explicitly.

The query “find a nearby bike shop” is also a geographic query because the word nearby implies the user is only interested in search results to points of interest nearby the user. Different methods of defining “nearby” can be used. As a starting point, a location of the device may be determined and then a threshold distance from the location used to define the area. Alternatively, a user's home location may be used instead of actual device location information. As an alternative to distance, government boundaries (e.g., cities, zip codes, counties) or other methods of delineating areas can be used.

At step 410, the geographic search query is communicated to an online search service over the network. The query may be received by a search application running on the client device. The search service may determine that the query is a geographic query.

At step 415, a search result set is received from the online search service. The search result set can comprise the top X results that the search service determined were the most relevant.

At step 420, the search result set is output for display. The result set can be output to a display integrated with the client device or an external display.

At step 425, supplemental geographic search result data related to the search result set from the online search service is received at the user device. The supplemental geographic search result data comprises data that is not part of the search result set. The supplemental search information for a query can include the search result set provided in response to the query. The supplemental search information for a query can also include supplemental search results not shown to a user. For example, the search result set shown to a user could include 15 search results with the highest relevancy scores. The supplemental search result data could include the next 50 search results, as an example, with the next highest relevancy scores. The search results could then be shown in response to the same query if submitted a second time when the device is offline. All or a portion of the search results could also be shown in response to a different query if the local search application determines that they are responsive to the different query. A new relevance rank may be assigned to each of the search results in response to a new or identical query. For example, a context change between receiving the query while online and receiving the same query offline can change the relevance of different results. For example, the relevance of results to a query “nearby restaurants” can change based on device location when a query is submitted.

The supplemental search data can also include point of interest data for points of interest in an area associated with a geographic query, but that are not in the search results. The point of interest data can be selected based on overall popularity within the geographic area. Popularity could be measured by interaction data collected from people in the area. The more people that visit a point of interest, the more popular it becomes. The point of interest data allows for search results including the point of interest to be generated and shown on a map while offline. Including the point of interest data for the most popular points of interest expands the scope of possible search results to beyond those related to recent queries.

The supplemental search data can also include content from web pages and websites linked to individual search results. In one aspect, each link in the search results is followed and content from the linked web page retrieved. The content can include images and text needed to reproduce the web page while offline. Additionally, links on the linked web page can be followed and content retrieved from those pages in order to display the pages offline. In one aspect, the entire website associated with a linked web page is retrieved for reproduction offline. A size limit may be imposed for larger websites to prevent the entire website from being stored offline. For example, a 10-page limit on a website may be used. The 10 pages with the highest relevance to the query may be selected.

The supplemental search data is different from device to device based on recently submitted queries. In contrast, generic offline map data may include information used to generate search results, but will be similar from device to device within a geographic area. The generic offline data can be based on crowdsourced data collection and designed to information about points of interest likely to be of interest to a large number of people.

At step 430, the supplemental geographic search result data is stored in computer storage on the user device.

At step 435, a new query is received at the user device when an application receiving the new query is offline. The new query can be received by a geographic search application, a search application, a map application, a personal assistant, or such. Different applications can receive the query and the new query. A lack of network connection can also be described as offline. A device can be offline when no network is available because of proximity (no signal), no access code (e.g., secured Wi-Fi), or a device setting limits access (e.g., search app does not have permission to use data connection even though user device is connected to a network). When the device is offline, then all applications on the device are offline. In some cases, user permissions or other factors can cause an application to be offline, though the device is online.

At step 440, a new search result set that is responsive to the new query is generated using the supplemental geographic search result data. The new search result set is generated by accessing the supplemental search result data and determining the most relevant data that is responsive to the query. The supplemental search result data can be indexed or otherwise organized for analysis by a search function.

At step 445, a geographic search result page comprising the new search result set is output for display. The new search result set can be displayed with a map that includes indicators showing a location of a point of interest associated with a search result. The new search result set may resemble the appearance of result sets generated while online. This helps make the online and offline experience transparent to the user.

The search results can be interactive because of content in the search result data. In one aspect, a selection of a search result in the new search result set is received while offline. Using the supplemental geographic search result data, a reproduction of a web page linked within the search results is generated while offline. As mentioned, the supplemental search data can comprise content retrieved from web pages linked in the search results. The content can be used to reproduce these pages. The reproduction of a web page can be output for display while offline.

The reproduced web page can similarly be interactive by the supplemental search data. A selection of a link in the reproduction of a website can be received while offline. Using the supplemental geographic search result data, a reproduction of an additional web page tied to the link is generated while offline. The reproduction of the additional web page is then output for display while offline.

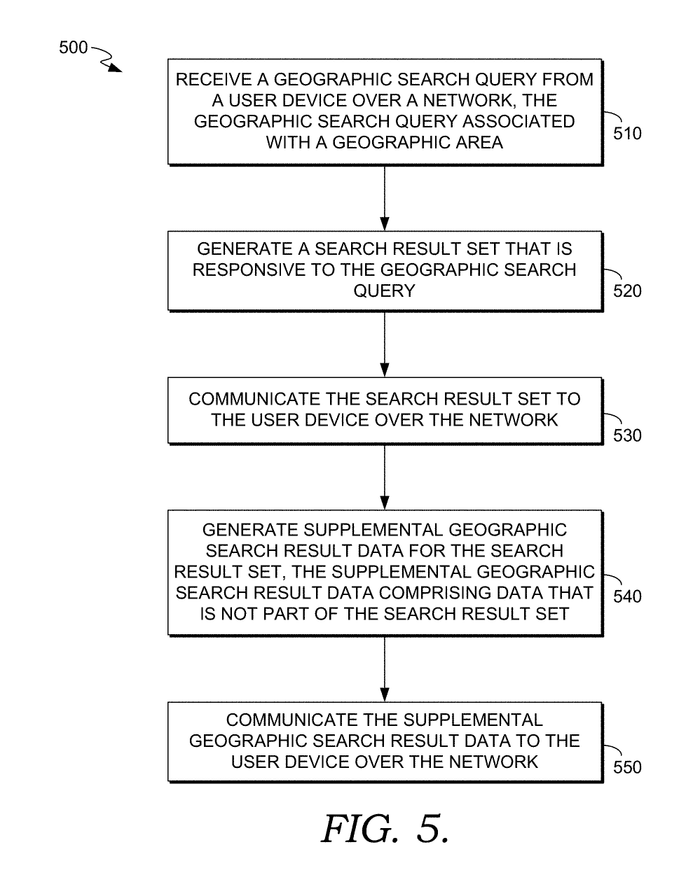

Turning now to FIG. 5, a flow chart showing a method 500 of generating supplemental geographic search result data for offline consumption is provided. Method 500 can be performed by a search service in one aspect.

At step 510, a geographic search query is received from a user device over a network. The geographic search query is associated with a geographic area. The geographic search query is associated with a geographic area. As an initial step, the query may be classified as a geographic query and the geographic area of interest determined. A geographic query is a query with an intent for results tied to a geographic area. For example, the query “find hardware stores in Overland Park, Kansas” is a geographic query because it is asking for hardware stores in the city of Overland Park, rather than anywhere. The geographic area can be determined implicitly or explicitly. In the previous query, the geographic area, Overland Park, is mentioned explicitly.

The query “find a nearby bike shop” is also a geographic query because the word nearby implies the user is only interested in search results to points of interest nearby the user. Different methods of defining “nearby” can be used. As a starting point, a location of the device may be determined and then a threshold distance from the location used to define the area. Alternatively, a user's home location may be used instead of actual device location information. As an alternative to distance, government boundaries (e.g., cities, zip codes, counties) or other methods of delineating areas can be used.

At step 520, a search result set that is responsive to the geographic search query is generated. The search result set can comprise the top X results that the search service determined were the most relevant.

At step 530, the search result set is communicated to the user device over the network.

At step 540, supplemental geographic search result data is generated for the search result set. The supplemental geographic search result data comprises data that is not part of the search result set. The supplemental geographic search result data comprises data that is not part of the search result set. The supplemental search information for a query can include the search result set provided in response to the query. The supplemental search information for a query can also include supplemental search results not shown to a user. For example, the search result set shown to a user could include 15 search results with the highest relevancy scores. The supplemental search result data could include the next 50 search results, as an example, with the next highest relevancy scores. The search results could then be shown in response to the same query if submitted a second time when the device is offline. All or a portion of the search results could also be shown in response to a different query if the local search application determines that they are responsive to the different query. A new relevance rank may be assigned to each of the search results in response to a new or identical query. For example, a context change between receiving the query while online and receiving the same query offline can change the relevance of different results. For example, the relevance of results to a query “nearby restaurants” can change based on device location when a query is submitted.

The supplemental search data can also include point of interest data for points of interest in an area associated with a geographic query, but that are not in the search results. The point of interest data can be selected based on overall popularity within the geographic area. Popularity could be measured by interaction data collected from people in the area. The more people that visit a point of interest, the more popular it becomes. The point of interest data allows for search results including the point of interest to be generated and shown on a map while offline. Including the point of interest data for the most popular points of interest expands the scope of possible search results to beyond those related to recent queries.

The supplemental search data can also include content from web pages and websites linked to individual search results. In one aspect, each link in the search results is followed and content from the linked web page retrieved. The content can include images and text needed to reproduce the web page while offline. Additionally, links on the linked web page can be followed and content retrieved from those pages in order to display the pages offline. In one aspect, the entire website associated with a linked web page is retrieved for reproduction offline. A size limit may be imposed for larger websites to prevent the entire website from being stored offline. For example, a 10-page limit on a website may be used. The 10 pages with the highest relevance to the query may be selected.

At step 550, the supplemental geographic search result data is communicated to the user device over the network.

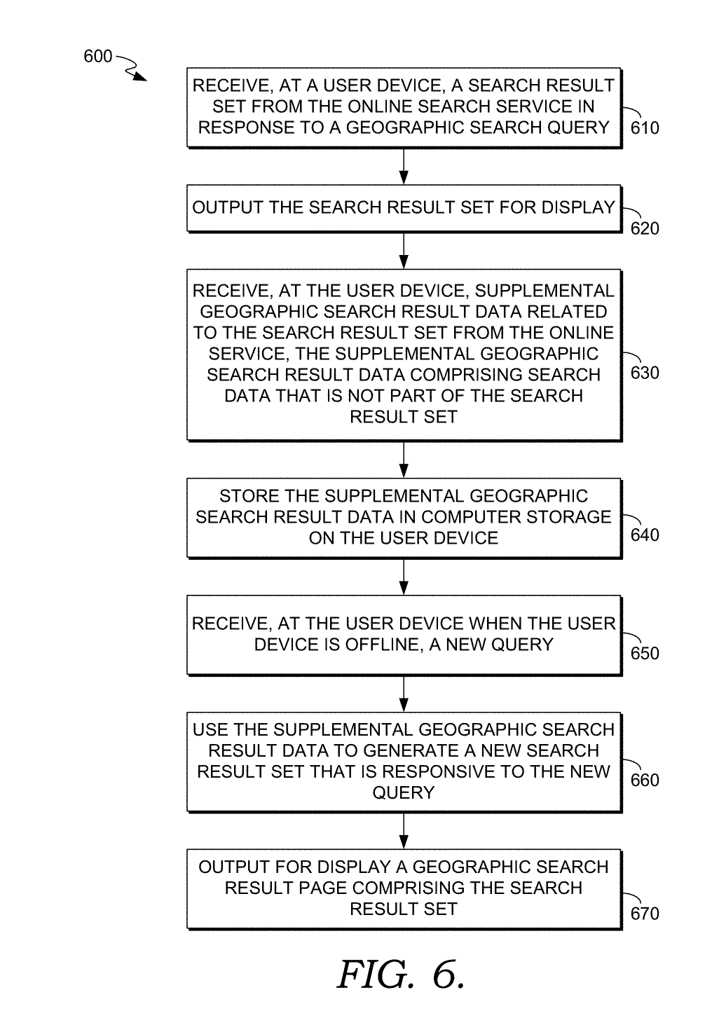

Turning now to FIG. 6, a flow chart showing a method 600 of using geographic search result data while offline to generate geographic search results is provided. Method 600 could be performed by a user device, in one aspect.

At step 610, a search result set is received from the online search service at a user device in response to a geographic search query. The search result set can comprise the top X results that the search service determined were the most relevant.

At step 620, the search result set is output for display. The result set can be output for display with a map that indicates a location of one or more entities that are a subject of the search results.

At step 630, supplemental geographic search result data related to the search result set from the online service is received at the user device. The supplemental geographic search result data comprises search data that is not part of the search result set. The supplemental search information for a query can include the search result set provided in response to the query. The supplemental search information for a query can also include supplemental search results not shown to a user. For example, the search result set shown to a user could include 15 search results with the highest relevancy scores. The supplemental search result data could include the next 50 search results, as an example, with the next highest relevancy scores. The search results could then be shown in response to the same query if submitted a second time when the device is offline. All or a portion of the search results could also be shown in response to a different query if the local search application determines that they are responsive to the different query. A new relevance rank may be assigned to each of the search results in response to a new or identical query. For example, a context change between receiving the query while online and receiving the same query offline can change the relevance of different results. For example, the relevance of results to a query “nearby restaurants” can change based on device location when a query is submitted.

The supplemental search data can also include point of interest data for points of interest in an area associated with a geographic query, but that are not in the search results. The point of interest data can be selected based on overall popularity within the geographic area. Popularity could be measured by interaction data collected from people in the area. The more people that visit a point of interest, the more popular it becomes. The point of interest data allows for search results including the point of interest to be generated and shown on a map while offline. Including the point of interest data for the most popular points of interest expands the scope of possible search results to beyond those related to recent queries.

The supplemental search data can also include content from web pages and websites linked to individual search results. In one aspect, each link in the search results is followed and content from the linked web page retrieved. The content can include images and text needed to reproduce the web page while offline. Additionally, links on the linked web page can be followed and content retrieved from those pages in order to display the pages offline. In one aspect, the entire website associated with a linked web page is retrieved for reproduction offline. A size limit may be imposed for larger websites to prevent the entire website from being stored offline. For example, a 10-page limit on a website may be used. The 10 pages with the highest relevance to the query may be selected.

At step 640, the supplemental geographic search result data is stored in computer storage on the user device.

At step 650, a new query is received at the user device when the user device is not online. The new query can be received by a geographic search application, a search application, a map application, a personal assistant, or such. Different applications can receive the query and the new query. A lack of network connection can also be described as offline. A device can be offline when no network is available because of proximity (no signal), no access code (e.g., secured Wi-Fi), or a device setting limits access (e.g., search app does not have permission to use data connection even though user device is connected to a network). When the device is offline, then all applications on the device are offline. In some cases, user permissions or other factors can cause an application or device to be offline because a data connection cannot be used, though the device has a data connection.

At step 660, the supplemental geographic search result data is used to generate a new search result set that is responsive to the new query.

At step 670, a geographic search result page comprising the new search result set is output for display. The new search result set can be displayed with a map that includes indicators showing a location of a point of interest associated with a search result. The new search result set may resemble the appearance of result sets generated while online. This helps make the online and offline experience transparent to the user.

The search results can be interactive because of content in the search result data. In one aspect, a selection of a search result in the new search result set is received while offline. Using the supplemental geographic search result data, a reproduction of a web page linked within the search result is generated while offline. As mentioned, the supplemental search data can comprise content retrieved from web pages linked in the search results. The content can be used to reproduce these pages. The reproduction of a web page can be output for display while offline.

The reproduced web page can similarly be interactive by the supplemental search data. A selection of a link in the reproduction of a website can be received while the offline. Using the supplemental geographic search result data, a reproduction of an additional web page tied to the link is generated while offline. The reproduction of the additional web page is then output for display while offline.

### Exemplary Operating Environment

Referring to the drawings in general, and initially to FIG. 7 in particular, an exemplary operating environment for implementing aspects of the technology described herein is shown and designated generally as computing device 700. Computing device 700 is but one example of a suitable computing environment and is not intended to suggest any limitation as to the scope of use of the technology described herein. Neither should the computing device 700 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, and an illustrative power supply 722. Bus 710 represents what may be one or more busses (such as an address bus, data bus, or a combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 7 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 7 and refer to “computer” or “computing device.”

Computing device 700 typically includes a variety of computer-readable media. Computer-readable media can be any available media that can be accessed by computing device 700 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or nonvolatile memory. The memory 712 may be removable, non-removable, or a combination thereof. Exemplary memory includes solid-state memory, hard drives, optical-disc drives, etc. Computing device 700 includes one or more processors 714 that read data from various entities such as bus 710, memory 712, or I/O components 720. Presentation component(s) 716 present data indications to a user or other device. Exemplary presentation components 716 include a display device, speaker, printing component, vibrating component, etc. I/O ports 718 allow computing device 700 to be logically coupled to other devices, including I/O components 720, some of which may be built in.

Illustrative 110 components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separated from an output component such as a display device, or in some aspects, the useable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 700. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

A computing device may include a radio 724. The radio 724 transmits and receives radio communications. The computing device may be a wireless terminal adapted to receive communications and media over various wireless networks. Computing device 700 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. One or more computer storage media comprising computer-executable instructions that when executed by a computing device cause the computing device to perform a method of using geographic search result data while offline to generate geographic search results, the method comprising:
receiving a geographic search query at a user device while the user computing device is online, the geographic search query is associated with a geographic area;
communicating the geographic search query to an online search service over a network;
receiving a search result set from the online search service;
outputting the search result set for display;
receiving, at the user device, supplemental geographic search result data related to the search result set from the online search service, the supplemental geographic search result data comprising data that is not part of the search result set;
storing the supplemental geographic search result data in computer storage on the user device;
receiving, at the user device, a new query while offline;
using the supplemental geographic search result data to generate a new search result set that is responsive to the new query; and
outputting for display a geographic search result page comprising the new search result set.

2. The media of claim 1, wherein the method further comprises:
receiving, at the user device, a selection of a search result in the new search result set while the user device is offline;
using the supplemental geographic search result data to generate a reproduction of a web page linked within the search results while the user device is offline; and
outputting for display the reproduction of a web page while the user device is offline.

3. The media of claim 2, wherein the method further comprises:
receiving, at the user device, a selection of a link in the reproduction of a website while the user device is offline;
using the supplemental geographic search result data to generate a reproduction of an additional web page tied to the link while the user device is offline; and
outputting for display the reproduction of the additional web page while the user device is offline.

4. The media of claim 1, wherein the method further comprises:
detecting a condition that satisfies a deletion trigger for the geographic search result data; and
deleting the supplemental geographic search result data.

5. The media of claim 4, wherein the condition is the user device exiting the geographic area.

6. The media of claim 4, wherein the condition is the passage of a threshold amount of time after storing the geographic search result data.

7. The media of claim 1, wherein the supplemental geographic search result data comprises point of interest data for a plurality of points of interest in the geographic area that are not part of the search result set.

8. The media of claim 7, wherein the plurality of points of interest are selected by a frequency of occurrence within geographic search results exceeding a threshold.

9. The media of claim 1, wherein the method further comprises communicating a request for supplemental geographic search data in response to detecting that the user device is only connecting to a local area network.

10. A method of generating supplemental geographic search result data for offline consumption, the method comprising:
receiving a geographic search query from a user device over a network, the geographic search query is associated with a geographic area;
generating a search result set that is responsive to the geographic search query;
communicating the search result set to the user device over the network;
generating supplemental geographic search result data for the search result set, the supplemental geographic search result data comprising data that is not part of the search result set; and
communicating the supplemental geographic search result data to the user device over the network.

11. The method of claim 10, wherein the method further comprises:
following a link within the search result set to accesses a first web page associated with the link;
retrieving a first web page content that allows the first web page to be reproduced offline; and
adding the first web page content to the supplemental geographic search result data.

12. The method of claim 11, wherein the method further comprises:
following an additional link on the web page to accesses a second web page associated with the additional link;
retrieving a second web page content that allows the second web page to be reproduced offline; and
adding the second web page content to the supplemental geographic search result data.

13. The method of claim 10, wherein the method further comprises:
determining a plurality of points of interest within the geographic area that have above a threshold amount of interaction, wherein the plurality of points of interest are not linked within the search result set; and
adding the point of interest data for the plurality of points of interest within the supplemental geographic search result data.

14. The method of claim 13, wherein the point of interest data includes location information for each point of interest that is useable to generate an indication that shows a location of an individual point of interest on a digital map.

15. The method of claim 10, wherein the method further comprises detecting a condition that satisfies a trigger that causes the supplemental geographic search result data to be generated.

16. A method of using geographic search result data while offline to generate geographic search results, comprising:
receiving, at a user device, a search result set from the online search service in response to a geographic search query;
outputting the search result set for display;
receiving, at the user device, supplemental geographic search result data related to the search result set from the online service, the supplemental geographic search result data comprising search data that is not part of the search result set;
storing the supplemental geographic search result data in computer storage on the user device;
receiving, at the user device when the user device is offline, a new query;
using the supplemental geographic search result data to generate a new search result set that is responsive to the new query; and
outputting for display a geographic search result page comprising the new search result set.

17. The method of claim 16, wherein the method further comprises:
receiving, at the user device, a selection of a search result in the new search result set while the user device is offline;
using the supplemental geographic search result data to generate a reproduction of a web page linked within the search results while the user device is offline; and
outputting for display the reproduction of a web page while the user device is offline.

18. The method of claim 17, wherein the method further comprises:
receiving, at the user device, a selection of a link in the reproduction of a website while the user device is offline;
using the supplemental geographic search result data to generate a reproduction of an additional web page tied to the link while the user device is offline; and
outputting for display the reproduction of the additional web page while the user device is offline.

19. The method of claim 16, wherein the supplemental geographic search result data comprises point of interest data for a plurality of points of interest in the geographic area that are not part of the search result set, wherein the plurality of points of interest are selected by a frequency of occurrence within geographic search results exceeding a threshold.

20. The method of claim 19, wherein the point of interest data includes location information for each point of interest that is useable to generate an indication that shows a location of an individual point of interest on a digital map.
